(19) United States
(12) Patent Application Publication
(10) Pub. No.: US 2024/0301955 A1
(43) Pub. Date: Sep. 12, 2024

(54) SOLENOID VALVE FOR ENGINE CONTROL

(71) Applicant: YAMABIKO CORPORATION, Tokyo (JP)

(72) Inventors: Takahiro YAMAZAKI, Tokyo (JP); Yuta ONUMA, Tokyo (JP); Tamotsu SAITO, Tokyo (JP); Tomoyoshi KUDO, Tokyo (JP); Ryosuke IMAI, Tokyo (JP)

(73) Assignee: YAMABIKO CORPORATION, Tokyo (JP)

(21) Appl. No.: 18/411,108

(22) Filed: Jan. 12, 2024

(30) Foreign Application Priority Data
Mar. 6, 2023 (JP) 2023-033541

(51) Int. Cl. F16K 1/42; F02M 37/00; F16K 31/06

(52) U.S. Cl. CPC F16K 1/42; F02M 37/0017; F16K 31/0655

(57) ABSTRACT

A movable valve element (24) is comprised of a valve member (22) and a leaf spring (26). A passage forming member (12) is securely fixed to a valve chamber forming member (10) that forms a valve chamber (S). The passage forming member (12) has a fluid passage (14) extending from one end to the other end thereof, with the one end (14a) of the fluid passage (14) constituting an outlet port of the valve chamber (S). The passage forming member (12) has an O-ring (20) surrounding and spaced apart from the outlet port (14a), the O-ring (20) constituting a valve seat. Spring force of the leaf spring (26) brings the valve member (22) into pressure contact with the O-ring (20), to form a closed valve state.

### BACK GROUND OF THE INVENTION

The present invention relates to a solenoid valve for engine control.

A solenoid valve is used to control liquid flow. A typical example thereof is engine control, in which the solenoid valve is used to control of fuel supply to the engine body. The solenoid, as is well known, includes a valve seat and a movable valve element that advances and retreats by the action of an electromagnetic coil. When the movable valve element advances to be seated on the valve seat, a closed valve state is formed. On the other hand, when the movable valve element retreats to be separated from the valve seat, an open valve state is formed.

JP6218777 discloses a solenoid valve that keeps its sealing properties in the closed valve state by metal-to-metal pressure contact. To give an overview of the solenoid valve of JP6218777, the solenoid valve includes an electromagnetic coil, a plunger unit having a plunger, and a valve body. The valve body has a movable valve element advancing and retreating by the plunger, and a valve seat on/from which the movable valve element is seated/separated. JP6218777 describes that this solenoid valve is used for normally closed control.

Specifically, a valve member of the movable valve element is comprised of a metal ball. On the other hand, the valve seat is comprised of a circumferential edge of an outlet port of a valve chamber. From this configuration, the solenoid valve of JP6218777 is classified into a metal contact type solenoid valve. The metal ball is biased toward a closed valve state direction by a coil spring. When the plunger advances so that the metal ball is seated on the circumferential edge of the outlet port, the solenoid valve goes to the closed valve state. In this closed valve state, the metal ball is biased toward the closing direction by the coil spring, to thereby keep the sealing properties.

Among the metal contact type solenoid valves, a solenoid valve is known in which the valve member and a leaf spring make up a valve part of the movable valve element, while the valve seat is comprised of a flat surface around the outlet port or inlet port of the valve chamber. In this solenoid valve, the closed valve state is formed when the valve member is seated on the flat surface around the port. In this closed valve state, sealing properties are ensured by a spring force of the leaf spring.

JP-A-1996-312826 discloses a solenoid valve whose valve seat is comprised of a thick block-shaped elastic member, the block-shaped elastic member forming the fluid outlet port or inlet port. The closed valve state is achieved when a plunger advances to come into contact with the elastic member to consequently close the outlet port or inlet port comprised of the elastic member. The solenoid valve of JP-A-1996-312826 is a so-called elastic seal type solenoid valve. Since the block-shaped elastic member defines the outlet port or inlet port of a valve chamber, a higher molding precision of the elastic member is required. Since a solenoid valve for engine control is small-sized, the elastic member is a small component. This makes it troublesome to ensure the molding precision of the elastic member, i.e., the precision of the outlet port or inlet port. It is also difficult to keep the precision of the outlet port or inlet port of the valve chamber over time by the elastic member.

The metal contact type solenoid valve embraces a problem that sealing properties are difficult to secure. To secure the sealing properties, the movable valve element needs to be pressed against the valve seat with a strong force. This results in a problem of rendering it difficult to improve the valve opening responsibility and provide delicate aperture control.

Additionally, in the solenoid valve whose movable valve element is composed of the valve member and the leaf spring, the spring force of the leaf spring needs to be increased for securing the valve closing and sealing properties. Since these valve member and leaf spring are small components, a problem occurs that the production cost becomes high for enhancing the sealing properties while keeping the machining precision.

As described above, the elastic seal type solenoid valve renders it troublesome to secure the molding precision of the elastic member forming the outlet port or inlet port of the valve chamber, as well as making it difficult to keep the precision of the outlet port or inlet port over time.

### SUMMARY OF THE INVENTION

An object of the present invention is to not only provide a solenoid valve for engine control, easy to secure sealing properties while keeping the molding precision of the outlet port or inlet port of the valve chamber, but also provide a solenoid valve for engine control capable of improvement in valve opening responsibility and of delicate aperture control.

The above technical difficulties can be overcome by the present invention below. That is, the present invention provides a solenoid valve for engine control comprising:
a valve seat; and
a movable valve element that advances and retreats by action of an electromagnetic coil, the movable valve element advancing to be seated on the valve seat to thereby form a closed valve state, the movable valve element retreating to be separated from the valve seat to thereby form an open valve state, characterized in that
the valve seat is comprised of an elastic sealing member, the elastic sealing member being arranged around an outlet port or inlet port of a valve chamber (S), the elastic sealing member surrounding the outlet port or inlet port at a position radially apart from the outlet port or inlet port, wherein
the movable valve element presses the elastic sealing member, whereby the closed valve state is formed with sealing properties kept.

The solenoid valve of the present invention is capable of forming the closed valve state and securing the sealing properties during the valve closing state, by the elastic sealing member surrounding the outlet port or inlet port at a position spaced apart from the outlet port or inlet port. Since this elastic sealing member does not constitute the outlet port or inlet port, close attention need not be paid to the shape precision of the elastic sealing member. In addition, the solenoid valve of the present invention is capable of eliminating the above defects of the metal contact type and elastic seal type. According to the present invention, there is no need to press the movable valve element against the valve seat with a strong force as the metal contact type solenoid valve does. Thus, the present invention achieves improvement in valve opening responsibility of the solenoid valve and facilitates the delicate aperture control. In the preferred embodiment, the elastic sealing member is comprised of the O-ring.

Functions and effects and other objects of the present invention will become apparent from the following detailed description of a preferred embodiment of the present invention.

### BRIEF DESCRIPTION OF THE DRAWINGS

FIG. 1 shows a cross-sectional view of a solenoid valve of an embodiment;

FIG. 2 shows a cross-sectional view for explaining arrangement of an O-ring included in the solenoid valve of the embodiment;

FIG. 3 shows a schematic cross-sectional view for explaining relative dimensions of the O-ring included in the embodiment and a valve member constituting a valve part of a movable valve element;

FIG. 4 shows a schematic cross-sectional view related to FIG. 3, for explaining relative dimensions which may not necessarily be desirable of the O-ring and the valve member;

FIG. 5 shows a cross-sectional view related to FIG. 2, showing a variant of an elastic sealing member included in the embodiment;

FIG. 6 shows a diagram for explaining an example of application of the solenoid valve of the embodiment to a conventional 2-stroke engine; and

FIG. 7 shows a diagram for explaining an example of application of the solenoid valve of the embodiment to a stratified scavenging engine.

### DETAILED DESCRIPTION OF THE PRESENT INVENTION

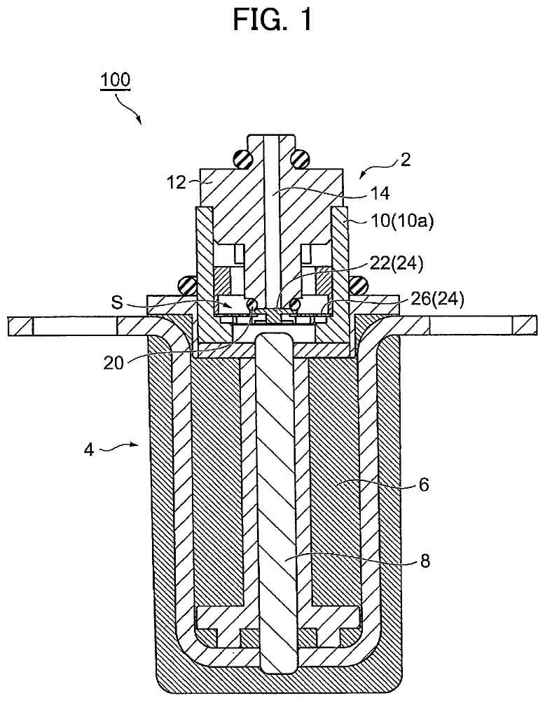

A preferred embodiment of the present invention will now be described with reference to the accompanying drawings. FIG. 1 shows a solenoid valve 100 of the embodiment. The solenoid valve 100 is used for fuel supply control of an engine (not shown). In FIG. 1, reference numeral 2 denotes a valve body and reference numeral 4 denotes an electromagnet unit. The electromagnet unit 4 includes an electromagnetic coil 6 and a core 8, as in the past.

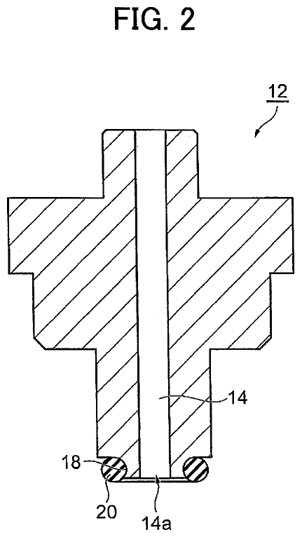

The valve body 2 has a valve chamber forming member 10 that forms a valve chamber S, and a passage forming member 12 that is securely fixed to a tubular part 10a of the valve chamber forming member 10, the passage forming member 12 being made of a metal. FIG. 2 is an enlarged cross-sectional view of the passage forming member 12. The passage forming member 12 has a fluid passage 14 extending from one end to the other end, the fluid passage 14 being made by drilling. An outlet port of the valve chamber S is consisted by an end 14a (FIG. 2) of the fluid passage 14. The passage forming member 12 has a circumferential groove 18 (FIG. 2) extending throughout the same circumference, with an O-ring 20 received in the circumferential groove 18 in intimate pressure contact. This can prevent the O-ring 20 from falling off unexpectedly. The O-ring 20 is a member constituting an “elastic sealing member” mentioned in the present invention and is a member constituting a “valve seat”.

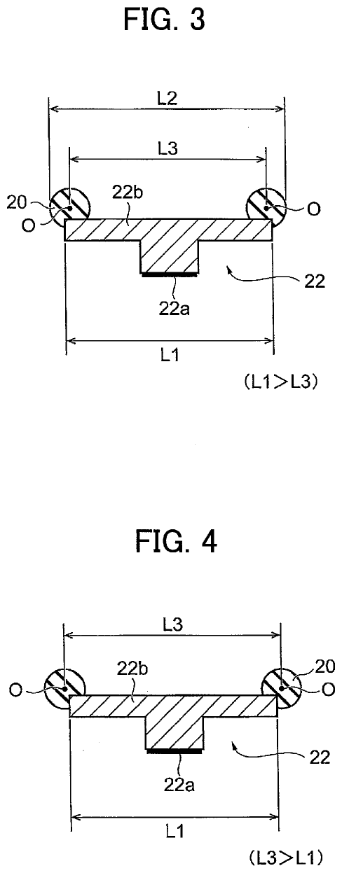

Referring to FIG. 1, reference numeral 22 denotes a valve member. The valve member 22 is arranged facing the outlet port 14a and constitutes a valve part of a movable valve element 24. The movable valve element 24 includes a leaf spring 26 supporting the valve member 22, the leaf spring 26 biasing the valve member 22 in the direction toward the valve closing. The valve member 22 and the leaf spring 26 may be separate components or may be a single component obtained by integrating them. The valve member 22 includes an armature 22a (FIG. 3, etc.). To avoid confusion in the diagram, the armature 22a is not illustrated in FIG. 1. When the core 8 becomes magnetic by the action of the electromagnetic coil 6, the armature 22a is magnetized to be attracted by the magnetic force of the core 8 so that the valve member 22 is displaced in the direction away from the O-ring 20. As a result, the solenoid valve 100 becomes open state. Conversely, when the core 8 is demagnetized, the valve member 22 presses the O-ring 20 by the biasing force of the leaf spring 26. In consequence, the solenoid valve 100 becomes closed state.

As can be understood immediately from the above configuration by any person skilled in the art, since the position to keep the closed state is not restrictive in forming and holding the closed state, as in the metal contact type solenoid valve, the solenoid valve 100 of the embodiment can keep the closed state stably. As can easily been understood from the drawings, the O-ring 20 is not a member that defines the outlet port 14a of the valve chamber S. As mentioned above, the outlet port 14a consists of one end opening of the fluid passage 14 of the passage forming member 12. Therefore, the fluid passage 14 can be formed by general machining, i.e., drilling. This enables the outlet port 14a to be formed with a high level of machining precision, which does not change over time as the prior elastic member does.

FIG. 3 is a diagram for explaining a most preferred relationship between the valve member 22 and the O-ring 20. The valve member 22 has a disk-shaped maximum diameter portion 22b that constitutes a main part of the valve member 22, the outer peripheral part of the disk-shaped maximum diameter portion 22b pressing the O-ring 20 to thereby form the closed state. In FIG. 3, reference numeral L1 denotes the diameter of the maximum diameter portion 22b. Reference numeral L2 denotes the outer circumferential diameter of the O-ring 20. Reference numeral L3 denotes the diameter of a center O in cross section cut through the O-ring 20.

The diameter L2 of the O-ring 20 is preferably a value greater than the diameter L1 of the maximum diameter portion 22b. Specifically, it is preferred to set the dimensions of the O-ring 20 so that the O-ring 20 deforms as follows when the outer peripheral part of the valve member 22 comes into pressure contact with the O-ring 20. That is, when the valve member 22 comes into pressure contact with the O-ring 20 to form the closed state, as shown in FIG. 3, it is preferred that the O-ring 20 deform partially in cross-sectional shape into an L-shape along the outer circumferential edge portion of the valve member 22. This deformation in cross-sectional shape of the O-ring 20 achieves improvement in the sealing properties.

Preferably, the outer circumferential diameter L2 of the O-ring 20 is greater than the diameter L1 of the maximum diameter portion 22b, while the diameter L3 of the center O in a cross section cut through the O-ring 20 is less than the diameter L1 of the maximum diameter portion 22b. This achieves restraint of deformation in cross-sectional shape of the O-ring 20 relative to the outer circumferential edge portion of the valve member 22 (disk-shaped maximum diameter portion 22b), into proper L-shape in cross section.

In other words, referring to FIG. 4, if the diameter L3 of the center O in a cross section cut through the O-ring 20 is set to a value greater than the diameter L1 of the maximum diameter portion 22b, the O-ring 20 may excessively bite into the outer circumferential edge portion of the valve member 22. This excessive “bite-into” phenomenon makes it hard for the valve member 22 to disengage from the O-ring 20 when the valve is opened, which may worsen the responsibility when changing from the closed state to the open state.

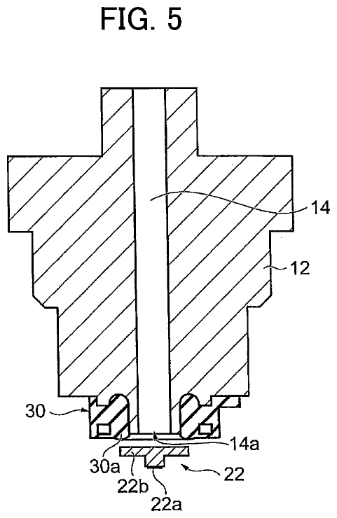

FIG. 5 is a diagram for explaining a variant of the elastic sealing member. Referring to FIG. 5, a seal rubber 30 is integrally molded with the passage forming member 12 that is a metal molding. The integrally molded seal rubber 30 has a sealing part 30a that extends circumferentially continuously around the outlet port 14a at a position radially outward apart from the outlet port 14a, the sealing part 30a protruding toward the valve member 22 with respect to the outlet port 14a. The sealing part 30a has a diameter allowing pressure contact of the outer peripheral portion of the valve member 22, to constitute the valve seat. Preferably, similar to the O-ring 20 described above, the sealing part 30a has a diameter allowing proper deformation in partial cross-sectional shape along the outer circumferential edge of the valve member 22. The proper deformation in cross-sectional shape of the sealing part 30a achieves improvement in the sealing properties without degrading the responsibility when changing from the closed state to the open state.

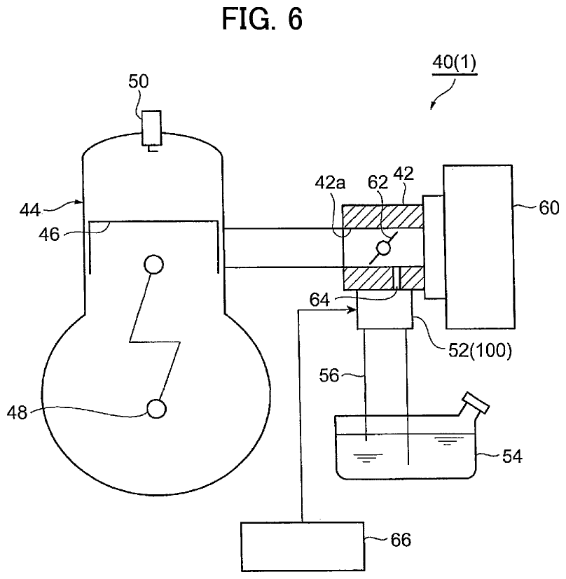

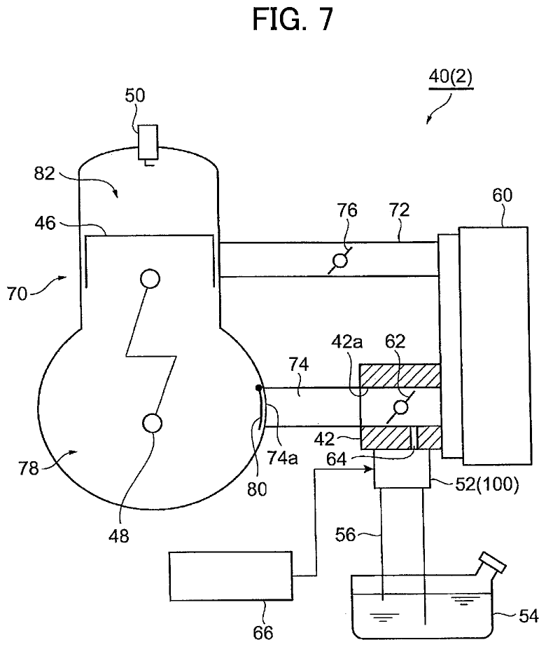

Typical examples of application of the solenoid valve 100 of the above embodiment and variant will be described with reference to FIGS. 6 and 7. FIGS. 6 and 7 illustrate examples of application of the solenoid valve 100 to a single cylinder 2-stoke engine 40 mounted on a working machine such as a brush cutter, a chainsaw or a small generator. Usage of the solenoid valve 100 preferably includes applying normally closed control to the solenoid valve 100.

An engine 40 (1) shown in FIG. 6 is a conventional engine in which air-fuel mixture generated by a carburetor 42 is supplied to an engine body 44. In FIG. 6, reference numeral 46 denotes a piston, reference numeral 48 denotes a crankshaft, and reference numeral 50 denotes a spark plug.

Fuel is supplied from a fuel tank 54 to a fuel supply member 52 included in the carburetor 42. Reference numeral 56 denotes a reflux pipe that returns fuel from the fuel supply member 52 to the fuel tank 54.

The carburetor 42 is supplied with air purified by an air cleaner 60. A mixture generation passage 42a of the carburetor 42 has a throttle valve 62, by which engine output is controlled. In the vicinity of the throttle valve 62, the carburetor 42 has a fuel supply port 64, to which controlled fuel is supplied from the fuel supply member 52. The fuel supply port 64 may communicate with a venturi leading to the mixture generation passage 42a or may be formed downstream (on the engine body side) of the carburetor 42.

The fuel supply member 52 includes the solenoid valve 100 of the embodiment, by which fuel supplied to the fuel supply port 64 is controlled. The solenoid valve 100 is controlled by a controller 66. The controller 66 generates a fuel supply control signal that controls opening of the solenoid valve 100 by a parameter such as engine rotation number.

An engine 40(2) shown in FIG. 7 is a stratified scavenging engine. In description of the engine 40(2) of FIG. 7, same elements as the elements included in the conventional engine 40(1) of FIG. 6 are designated by the same reference numerals and will not therefore be described again. The stratified scavenging engine 40(2) includes a leading air passage 72 supplying air purified by the air cleaner 60 to an engine body 70, and a mixture passage 74 supplying air-fuel mixture generated by the carburetor 42 to the engine body 70. The leading air passage 72 has a leading air control valve 76 that works in conjunction with the throttle valve 62.

In the stratified scavenging engine 40(2), as is well known, at the beginning of the scavenging process, air is supplied through the leading air passage 72 to the engine body 70, and then air-fuel mixture is supplied through the mixture passage 74 to the engine body 70. In the stratified scavenging engine 40(2) shown, air-fuel mixture is supplied to a crankcase 78. A reed valve 80 is arranged at an exit 74a of the mixture passage 74 that opens to the crankcase 78. As is well known, air-fuel mixture supplied to the crankcase 78 is pre-compressed within the crankcase 78 and then supplied through a scavenging passage (not shown) to a combustion chamber 82. The scavenging passage is well known.
100 solenoid valve of the embodiment
S valve chamber
12 passage forming member
14 fluid passage of passage forming member
14a outlet port of valve chamber
20 O-ring (clastic sealing member)
22 valve member
24 movable valve element
26 leaf spring
30 integrally-molded seal rubber of variant of elastic sealing member

What is claimed is:

1. A solenoid valve for engine control comprising:
a valve seat; and
a movable valve element that advances and retreats by action of an electromagnetic coil, the movable valve element advancing to be seated on the valve seat to thereby form a closed valve state, the movable valve element retreating to be separated from the valve seat to thereby form an open valve state, characterized in that
the valve seat is comprised of an elastic sealing member, the elastic sealing member being arranged around an outlet port or inlet port of a valve chamber, the elastic sealing member surrounding the outlet port or inlet port at a position radially apart from the outlet port or inlet port, wherein
the movable valve element presses the elastic sealing member, whereby the closed valve state is formed with sealing properties kept.

2. The solenoid valve for engine control of claim 1, wherein
the elastic sealing member is comprised of an O-ring.

3. The solenoid valve for engine control of claim 2, comprising
a circumferential groove extending around the outlet port or inlet port of the valve chamber throughout a circumference thereof, wherein
the O-ring is received within the circumferential groove in an intimate pressure contact state.

4. The solenoid valve for engine control of claim 1, comprising:
a passage forming member including the outlet port or inlet port of the valve chamber, wherein
the elastic sealing member is comprised of a seal rubber integrally molded with the passage forming member.

5. The solenoid valve for engine control of claim 1, wherein
the movable valve element is comprised of a valve member and a leaf spring supporting the valve member, and wherein
the valve member is biased by the leaf spring.

6. The solenoid valve for engine control of claim 5, wherein
when the closed valve state is formed by pressing the elastic sealing member by an outer peripheral part of the valve member, the elastic sealing member deforms in cross-sectional shape along an outer circumferential edge portion of the valve member.
